(19) United States
(12) Patent Application Publication
(10) Pub. No.: US 2006/0041914 A1
(43) Pub. Date: Feb. 23, 2006

(54) Method and system of providing media signals to hotels

(76) Inventors: Joshua Seiden, Highlands Ranch, CO (US); Douglas Will, Parker, CO (US)

Correspondence Address: BROOKS KUSHMAN P.C., 1000 TOWN CENTER, TWENTY-SECOND FLOOR, SOUTHFIELD, MI, 48075, US

(21) Appl. No.: 10/920,891

(22) Filed: Aug. 18, 2004

(51) Int. Cl. H04N 7/18; H04N 7/173

(52) U.S. Cl. 725/78; 725/80; 725/100; 725/119; 725/120

(57) ABSTRACT

A method and system of providing media services to a hotel. The method and system include receiving media signals at a hotel from a media provider located remotely from the hotel that represent media services provided to the hotel for in-room usage. The method and system includes storing data relating to the in-room usage of the media services at the remotely located media provider.

### BACKGROUND OF THE INVENTION

1. Field of the Invention

The present invention relates to providing media signals to hotels having a plurality of hotel rooms.

2. Background Art

Hotels receive media signals for providing in-room media services to their customers, such as basic television, cable television, satellite television, internet access, telephone access, and others. Each of these services can further include pay-per-view and/or pay-per-use services, such as pay-per-view movies and pay-per-byte internet access.

Billing the hotel customers for usage of such media services can be problematic. The hotels are typically billed on a monthly basis by a source of the media signals. The hotel in turn bills the customers on a daily or multiple-day basis. The problem lies with the hotel determining the individual bill for each customer on a daily basis when the hotel has yet to receive its monthly bill from the media provider.

Known systems have overcome the billing problem by constructing a dedicated networking infrastructure within the hotel that permits the hotel to track and monitor in-room usage of media services. The in-room usage of media services can be monitored and stored at the hotel for use in billing customers on a daily basis.

However, the hotel infrastructure is substantial and expensive as it mimics the expensive head-end units typically employed by the media provider. It is desirable to invent a more cost-effective means for providing the media services to the hotel rooms.

### SUMMARY OF THE INVENTION

The present invention overcomes the limitations of the prior art with a more cost-effective method and system for providing media signals to hotels. The present invention contemplates a number of features, including a method and system that utilizes residential cable services to provide in-room media signals.

One aspect of the present invention relates to a system for providing in-room media signals to a hotel having a plurality of hotel rooms with at least one media output device in at least a portion of the hotel rooms. The system includes a set-top box (STB) connected to each media output device. The STB receives media signals from a remotely located media provider and outputs the received signals to the media output device, which in turn outputs the media services represented by the media signals.

In accordance with one aspect of the present invention, the STBs are configured to communicate data to the remotely located media provider to indicate in-room usage of the media services. The data is stored remotely from the hotel on a memory at the media provider and accessed for billing the hotel for the in-room usage of media services.

Another aspect of the present invention relates to a graphical user interface (GUI) that is configured to operate on a computer at the hotel for remotely accessing the data stored at the media provider, such as to calculate a customer bill for the in-room usage of media services. In this manner, hotel personnel can generate a customer bill for the hotel's customers during checkout that bills the customers on a daily basis for pay-per-use services consumed by the customer during their stay at the hotel.

Another aspect of the present invention relates to a method for providing media services to a plurality of hotel rooms. The method includes connecting a hotel to a residential cable network so as to mimic the hotel as a residential subscriber, and delivering the media signals over the residential cable network to the at least a portion of the hotel rooms in the hotel. In accordance with one aspect of the present invention, the method further comprises delivery of in-room media usage data to the hotel from the residential cable source so that the hotel can generate a customer bill for the usage of media service by the customer.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a system for providing media signals in accordance with the present invention.

### DETAILED DESCRIPTION OF THE PREFERRED EMBODIMENT(S)

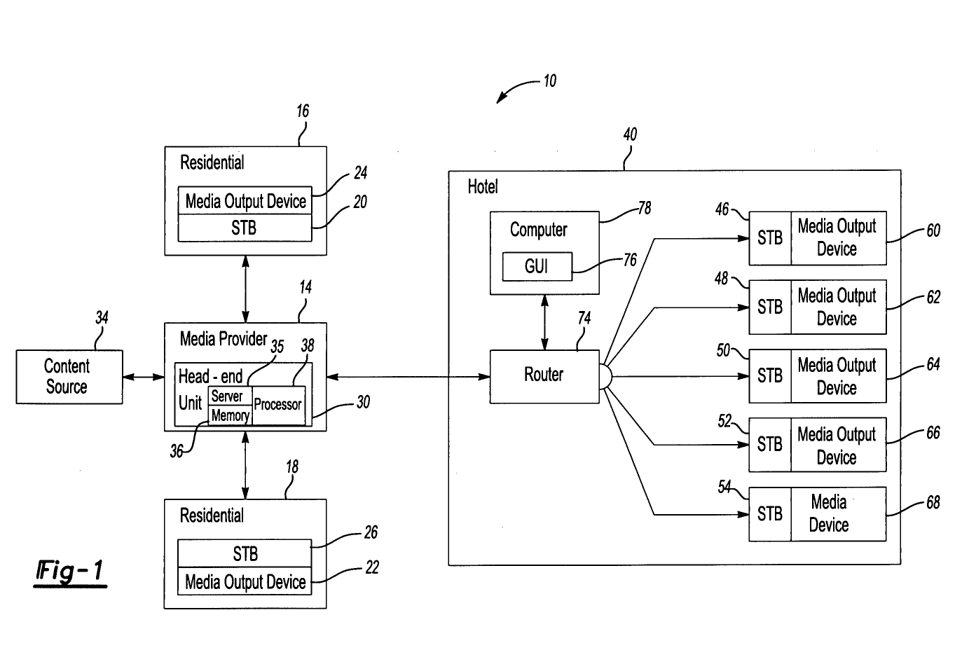

FIG. 1 illustrates a system 10 for providing media signals in accordance with one aspect of the present invention. The system 10 includes a media provider 14 for delivering media signals to a first residential subscriber 16 and a second residential subscriber 18. The premises equipment of subscribers 16 and 18 includes a set-top box (STB) 20 and 22 and a media output device 24 and 26. The STBs 22 and 24 receive the media signals and configure the received signals for output to media output devices 24 and 26. Although only two different subscribers are depicted herein for clarity, it is understood that media provider 14 can service many more subscribers.

The media output devices 24 and 26 can be a television, a telephone, a modem, a computer, and the like. The STBs 20 and 22 can be a separate item from the media output device and/or it can be integrated into the electronics of the device. The media services can include television, cable television, satellite television, internet access, telephone access, and others. Each of these services can further include pay-per-view or pay-per-use services, such as pay-per-view movies and pay-per-byte internet access.

The media provider 14 is preferably a residential cable provider. The provider 14 includes a head-end unit 30 or similar device for delivering the media signals to the subscribers 16 and 18. A cable or wireless connection connects the subscribers 16 and 18 to the head-end unit 30. The head-end unit 30 receives the media signals and content they provide to the subscribers 16 and 18 from a content source 34. The content source 34 provides the content of the television services, cable services, satellite services, internet services, and telephone services to the head-end unit 30 of the media provider 14.

The configuration of the head-end unit 30 permits it to communicate with the content source 34. The head-end unit 30 includes one or more servers 35, a memory 36, and a processor 38 for such communication. The head-end unit 30 can include an internet server 35 for connecting to an internet content provider 34. The head-end unit 30 can include a receiver (not shown) for communication with a network television content source 34. The present invention is not limited to a particular internet source 34 or network television content source 34. Other configurations are contemplated for the head-end. In accordance with one aspect of the present invention, the media provider 14 is an existing residential cable provider.

One aspect of the present invention relates to providing the media services to a hotel 40 in a cost-effective manner by connecting the hotel 40 to the media provider 14 as if the hotel 40 is a typical residential subscriber. The connection leverages off the existing infrastructure of the media provider 14 to eliminate the cost of establishing a head-end type device at the hotel 40. The hotel 40 essentially mimics a residential subscriber having a number of STBs 46, 48, 50, 52, and 54.

The STBs 46, 48, 50, 52, and 54 are included in a plurality, but not necessarily all, of the hotel's rooms. Like the subscriber STBs 16 and 18 described above, the hotel STBs 46, 48, 50, 52, and 54 receive media signals from the media provider 14. The STBs 46, 48, 50, 52, and 54 convert, manipulate, or relay the signals into a format or protocol understood by a number of media output devices 60, 62, 64, 66, and 68 connected thereto. Of course, the number of STBs depicted herein for hotel 40 is merely exemplary, and hotel 40 can include a fewer or greater number of STBs in accordance with the present invention.

In accordance with one aspect of the present invention, a router 74 is a preferred option for relaying the media signals received from the media provider 14 to each STB 46, 48, 50, 52, and 54. The router 74 receives media signals from the media provider 14 over a common line and delivers the media signals over separate lines to each STB 46, 48, 50, 52, and 54. The router 74 is a low-cost item for relaying the signals to each hotel room and can be beneficial for maintaining signal power levels. The router 74 can be expanded to output additional lines to new hotel rooms and/or to output second lines to existing hotel rooms.

In another approach, the router 74 can be replaced with a wireless device (not shown). The wireless device relays wireless signals to the STBs 46, 48, 50, 52, and 54. The media provider 14 could also operate wirelessly with the wireless device to provide a wireless system. The wired system is preferred over such a wireless system because it leverages off the existing cable infrastructure to provide a more cost-effective system. In the future, a residential wireless system may be constructed, in which case, it may be similarly cost-effective to leverage off of existing residential wireless infrastructures.

The STBs 46, 48, 50, 52, and 54 in the system 10, regardless of whether it is a residential or hotel STB, communicate identifying signals to the head-end unit 30. The head-end unit 30 stores each identified STB with data representing its usage of media services. The data can be stored at the media provider 14 on the memory 36, such as with an address for each of the STBs 46, 48, 50, 52, and 54. The address can be located in the memory 36 to locate the corresponding usage data by a processing means (not shown) at the head-end unit 30.

The usage of media services by each of the STBs 46, 48, 50, 52, and 54 is tracked for billing purposes. The STBs 46, 48, 50, 52, and 54 record each ordered movie and/or downloaded data volume and delivers signals representing such usage to the head-end unit 30. The STBs 46, 48, 50, 52, and 54 can be configured to feedback signals indicating any usage of media signals. The feedback signals are typically limited to the pay-per-view and/or pay-per-download services as the residential subscribers and the hotel receive a flat rate for the more standard services.

The head-end unit 30 includes software for controlling the processor 38 and the memory 36 for storing the data relating to the in-room usage of media services. The processor 28 can manipulate the stored data for generating customer bills so that the customer bills can be compiled monthly and sent to the subscribers, including hotel 40, for payment. A hotel having 100 STBs for separate televisions, for example, would receive a total bill detailing its flat-rate fees and its pay-per-use fees. Optimally, the pay-per-use fee can be itemized for each individual STB.

One aspect of the present invention relates to a graphical user interface (GUI) 76 configured to access the data stored at the media provider 14. In one approach, the GUI 76 is configured for operation on a computer 78 at the hotel 40. A hotel employee can operate the GUI 76 from the hotel 40 to remotely access the data stored at the media provider 14. The GUI 76 is configured with the assistance of the media provider 14 as it may be necessary for the media provider 14 to permit the GUI 76 to interface with the proprietary head-in protocols of the media provider 14.

The computer 78 can including any number of features and processing means, including a transceiver (not shown) for receiving and transmitting signals to and from the head-end unit 30 over the existing residential infrastructure. The GUI 76 executes software protocols that allow the GUI 76 to access that data stored at the head-end unit 30, such as to access the media usage data stored at the head-end unit 30 for each of the STBs 46, 48, 50, 52, and 54 in the hotel 40.

A log-in process can be instigated to identify the GUI 76 with the requesting hotel 40. Multiple hotels can be connected to the residential infrastructure and separately identified through the log-in process. Preferably, the GUI 76 at one hotel 40 is prohibited from accessing data on the head-end unit 30 relating to the residential subscribers 16,18 or other hotels. The GUI 76 can be configured with affiliations. The affiliations permit an affiliated GUI 76 to access data stored at the head-end unit 30 for other hotels that are in an affiliated hotel chain, for example.

The GUI 76 is preferably at least configured to calculate a bill for the usage of media services based on the in-room media usage data stored at the head-end unit 30 for each STB 46, 48, 50, 52, and 54. The hotel 40 can then charge the customer at checkout for any media services not already included in the room charge, such as the pay-per-use media services. The ability for the hotel 40 to charge the customers on a daily basis at checkout is advantageous as it allows the hotel to recoup the fees it will pay the media provider when the hotel is billed at the end of the month. Moreover, the GUI 76, computer 78, and router 74 are relatively inexpensive items which the hotel 40 can purchase in a cost-effective manner. The present invention in this manner provides a cost-effective method and system for providing the media signals to the hotel 40.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of providing media services to a hotel, the method comprising:
receiving media signals at the hotel from a media provider located remotely from the hotel, the media signals representing the media services;
delivering the received media signals to a plurality of hotel rooms for in-room media usage; and
storing data relating to in-room usage of the media services at the remotely located media provider.

2. The method of claim 1 further comprising receiving a request from the hotel to access the stored data for use in billing customers.

3. The method of claim 2 further comprising configuring a graphical user interface (GUI) arranged to be in communication with the media provider and for operation from the hotel for remotely accessing the in-room media usage data stored at the media provider.

4. The method of claim 3 further comprising configuring the GUI to calculate a customer bill for media services from the in-room media usage data stored at the media provider.

5. The method of claim 1 further comprising billing the hotel on a non-daily basis for total in-room media usage by the hotel over a period corresponding to the non-daily basis.

6. The method of claim 1 further comprising a second hotel receiving media signals from the media provider and each hotel logging into the media provider to receive data stored therein relating to the logged in hotel's in-room usage of media services.

7. The method of claim 1 further comprising providing a set-top box (STB) in each of the plurality of hotel rooms for receiving the media signals from the media provider and for outputting the received media signals to a media output device.

8. The method of claim 7 further comprising receiving signals from each STB for identifying the in-room media usage of each hotel room.

9. The method of claim 1 further comprising receiving the media signals from a residential cable provider.

10. The method of claim 1 further comprising connecting the hotel to an existing residential cable infrastructure to mimic the hotel as a residential subscriber, wherein the hotel receives the media signals over the existing residential cable infrastructure.

11. The method of claim 1 further comprising providing a router at the hotel for relaying the media signals received from the media provider to the plurality of hotel rooms in the hotel.

12. A system for providing in-room media signals to a hotel having a plurality of hotel rooms with at least one media output device in at least a portion of the hotel rooms, the system comprising:
a set-top box (STB) connected to each media output device for receiving media signals and outputting the received media signals to the media output device;
a media provider located remotely from the hotel for delivering the media signals representing the media services to the STBs, the media provider storing data relating to in-room usage of the media services.

13. The system of claim 12 further comprising a graphical user interface (GUI) in communication with the media provider and for operation from the hotel for remotely accessing the in-room media usage data stored at the media provider.

14. The system of claim 13 wherein the GUI is configured to calculate a customer bill for the media services from the in-room media usage data stored at the media provider.

15. The system of claim 12 wherein the STBs communicate identifying signals to the media provider for identifying a customer with the stored in-room media usage data.

16. The system of claim 12 wherein the media provider is a residential cable provider.

17. The system of claim 12 wherein the media provider delivers the signals to the STB over an existing residential cable infrastructure to mimic the hotel as a residential subscriber.

18. The system of claim 12 wherein the media provider includes a head-end unit.

19. The system of claim 12 further comprising a router at the hotel for relaying the media signals received from the media provider to each STB.

20. A method for providing in-room media services to a hotel having a plurality of hotel rooms, the method comprising:
connecting the hotel to an existing residential cable infrastructure of a cable provider so as to mimic the hotel as a residential subscriber, and
delivering media signals relating to the media services over the existing residential cable infrastructure to at least a portion of the plurality of hotel rooms.

21. The method of claim 20 further comprising storing data for in-room usage of media services at a media provider located remotely from the hotel.

22. The method of claim 21 further comprising configuring the media provider to permit remote access to in-room media usage data stored at the media provider from a graphical user interface (GUI) configured to operate at the hotel.

23. The method of claim 22 further comprising configuring the GUI to calculate a customer bill from in-room media usage of data stored at the media provider.

24. The method of claim 21 further comprising delivering the media signals to the hotel from a head-end unit of the media provider, the head-end unit located remotely from the hotel.

25. A graphical user interface (GUI) for operation at a hotel having a plurality of hotel rooms receiving media signals from a remote media provider, the GUI configured for:
remotely accessing data stored at the media provider relating to in-room usage of media services from the hotel.

26. The GUI of claim 24 further configured to calculate a customer bill relating to the in-room usage of media services.

27. The GUI of claim 24 further configured to communicate with the media provider over an existing residential cable infrastructure.
